(19) United States
(12) Patent Application Publication
(10) Pub. No.: US 2019/0111941 A1
(43) Pub. Date: Apr. 18, 2019

(54) SERVER DEVICE AND VEHICLE SYSTEM

(71) Applicant: TOYOTA JIDOSHA KABUSHIKI KAISHA, Toyota-shi (JP)

(72) Inventors: Takashige HORI, Aisai-shi (JP); Makoto AKAHANE, Nagoya-shi (JP)

(73) Assignee: TOYOTA JIDOSHA KABUSHIKI KAISHA, Toyota-shi (JP)

(21) Appl. No.: 16/156,533

(22) Filed: Oct. 10, 2018

(30) Foreign Application Priority Data
Oct. 12, 2017 (JP) 2017-198647

(51) Int. Cl. B60W 50/14; G05D 1/02

(52) U.S. Cl. CPC B60W 50/14; B60W 2550/40; G05D 1/021

(57) ABSTRACT

In a server device, a storage unit stores a recommended traveling situation in which use of a vehicle function provided by a vehicle is recommended. When traveling conditions of a vehicle of a user who is not using the vehicle function correspond to the recommended traveling situation, a notification unit notifies the vehicle of a proposal for using the vehicle function. The user who is not using the vehicle function is a user who has not used the vehicle function since the user used the vehicle function when the traveling conditions of the vehicle did not correspond to the recommended traveling situation.

The disclosure of Japanese Patent Application No. 2017-198647 filed on Oct. 12, 2017 including the specification, drawings and abstract is incorporated herein by reference in its entirety.

### BACKGROUND

### 1. Technical Field

The present disclosure relates to a server device and a vehicle system configured to notify a vehicle driver of information.

### 2. Description of Related Art

A technology is known by which, when the traveling environments, such as the road type, of a vehicle satisfy the judgment conditions used to judge suitability of use of a vehicle function, use of the vehicle function is proposed to the user of the vehicle (see JP-A-2016-16765, for example).

With the abovementioned technology, however, whether or not to propose use of a function to a user is determined based on how the user has used the function therebefore. For such a proposal of a vehicle function, there is room for improvement.

### SUMMARY

The embodiment addresses the above-described issue, and a general purpose thereof is to provide a server device and a vehicle system capable of proposing use of a vehicle function more appropriately.

To resolve the issue above, a server device of an embodiment includes: a storage unit storing a recommended traveling situation in which use of a vehicle function provided by a vehicle is recommended; and a notification unit configured to notify, when traveling conditions of a vehicle of a user who is not using the vehicle function correspond to the recommended traveling situation, the vehicle of a proposal for using the vehicle function. The user who is not using the vehicle function is a user who has not used the vehicle function since the user used the vehicle function when the traveling conditions of the vehicle did not correspond to the recommended traveling situation.

According to the embodiment, a proposal for using a vehicle function can be offered to a user who is likely to need the proposal. Therefore, use of a vehicle function can be appropriately proposed.

The server device may further include: an acquirer configured to acquire vehicle information of a plurality of vehicles; a deriver configured to derive traveling conditions of a vehicle when a user uses the vehicle function, on the basis of the vehicle information of the plurality of vehicles acquired by the acquirer; and an extractor configured to extract the recommended traveling situation from traveling conditions derived by the deriver and to store the recommended traveling situation thus extracted in the storage unit.

When traveling conditions of a vehicle at the time when a user last used the vehicle function corresponded to the recommended traveling situation, the notification unit need not notify the vehicle of the user of a proposal for using the vehicle function.

Another embodiment relates to a vehicle system. The vehicle system includes: a server device; and a vehicle-mounted device mounted on a vehicle and configured to communicate with the server device. The server device includes: a storage unit storing a recommended traveling situation in which use of a vehicle function provided by a vehicle is recommended; and a notification unit configured to notify, when traveling conditions of a vehicle of a user who is not using the vehicle function correspond to the recommended traveling situation, the vehicle of a proposal for using the vehicle function. The user who is not using the vehicle function is a user who has not used the vehicle function since the user used the vehicle function when the traveling conditions of the vehicle did not correspond to the recommended traveling situation. The vehicle-mounted device receives a proposal for using the vehicle function from the notification unit of the server device.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 is a block diagram that shows a configuration of a vehicle system according to an embodiment;

FIG. 2 is a block diagram that shows a configuration of a vehicle-mounted device shown in FIG. 1;

FIG. 3 is a block diagram that shows a configuration of a server device shown in FIG. 1;

FIG. 4 is a flowchart that shows processing for extracting a recommended traveling situation performed by the server device shown in FIG. 1; and

FIG. 5 is a flowchart that shows processing for notification of a proposal for using a vehicle function performed by the server device shown in FIG. 1.

### DETAILED DESCRIPTION

Various embodiments now will be described. The embodiments are illustrative and are not intended to be limiting.

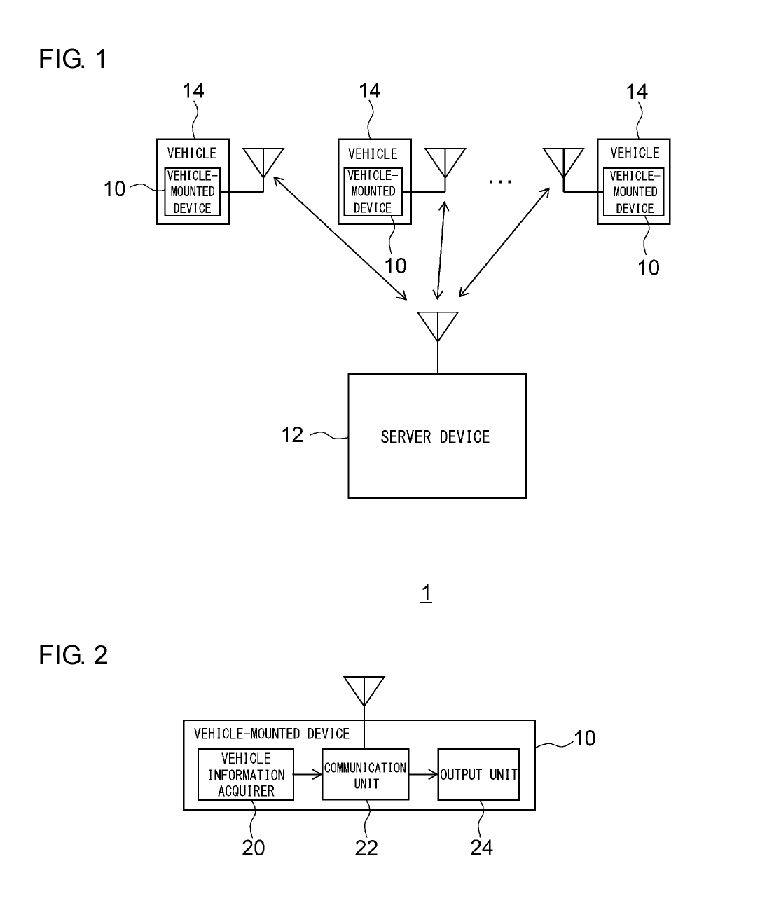

FIG. 1 is a block diagram that shows a configuration of a vehicle system 1 according to an embodiment. The vehicle system 1 comprises multiple vehicle-mounted devices 10 and a server device 12. FIG. 1 shows three vehicle-mounted devices 10 among the multiple vehicle-mounted devices 10.

Each vehicle-mounted device 10 is mounted on a vehicle 14, which is an automobile. Each vehicle-mounted device 10 performs wireless communication with the server device 12. The wireless communication standard is not particularly limited, and may be 3G (third-generation mobile communication system), 4G (fourth-generation mobile communication system), or 5G (fifth-generation mobile communication system), for example. Each vehicle-mounted device 10 may perform wireless communication with the server device 12 via a base station, which is not illustrated. The server device 12 may be installed in a data center, for example, and functions as an information processor for processing big data transmitted from the multiple vehicle-mounted devices 10.

FIG. 2 is a block diagram that shows a configuration of a vehicle-mounted device 10 shown in FIG. 1. The vehicle-mounted device 10 comprises a vehicle information acquirer 20, a communication unit 22, and an output unit 24. The vehicle information acquirer 20 regularly acquires vehicle information of the subject vehicle, on which the vehicle-mounted device 10 is mounted, and outputs the vehicle information to the communication unit 22. The frequency of acquiring vehicle information can be appropriately determined through experiments or the likes, and may be once every several seconds, for example. The frequency of acquiring vehicle information may be different for each type of vehicle information. The vehicle information may include position information of the subject vehicle, bearing information indicating the traveling direction of the subject vehicle, speed information of the subject vehicle, and operation status information of each vehicle function provided by the subject vehicle, for example. The position information may be acquired from a GPS receiver, not illustrated, for example. The bearing information and speed information may be acquired from various sensors, not illustrated, for example.

The operation status information of a vehicle function may be acquired from a control signal for controlling the ON or OFF status of the vehicle function. Each vehicle function is not automatically activated, and the ON and OFF status of the vehicle function is switched therebetween based on an operation provided by the user, i.e., the driver. Vehicle functions are effective in reducing the user's burden and improving the user's convenience, and may include “Adaptive Cruise Control (ACC)”, “Lane Keeping Assist (LKA)”, “Shift B”, “ECO mode”, and “Sport mode”, for example. The “ACC” is a function to automatically perform constant speed traveling of a vehicle while maintaining a constant distance from the vehicle-in-front. The “LKA” is a function to prevent a traveling vehicle 14 from drifting from the lane. The “Shift B” is a function to use engine braking. The “ECO mode” is a function to improve fuel economy. The “Sport mode” is a function to improve the responsiveness of engine power output with respect to accelerator operation.

The communication unit 22 performs wireless communication with the server device 12. The communication unit 22 regularly transmits, to the server device 12, vehicle information acquired by the vehicle information acquirer 20. The frequency of transmitting vehicle information can be appropriately determined through experiments or the likes. For example, the frequency of transmitting vehicle information may be lower than the frequency of acquiring vehicle information, and, in this case, accumulated vehicle information will be collectively transmitted. To the vehicle information to be transmitted, information for identifying the vehicle 14 as the transmission source, information for identifying the user, and information of transmission date and time is attached. The information for identifying the user may be acquired using a publicly-known technology, such as a reading device for reading information of a mobile device, including a smartphone, possessed by the user, and an in-vehicle camera for acquiring an image of the user.

When information of a proposal for using a vehicle function is transmitted from the server device 12 to the subject vehicle, the communication unit 22 receives the information of a proposal for using a vehicle function. Thereafter, the output unit 24 provides the proposal for using a vehicle function to the user. The communication unit 22 and the output unit 24 will be detailed later.

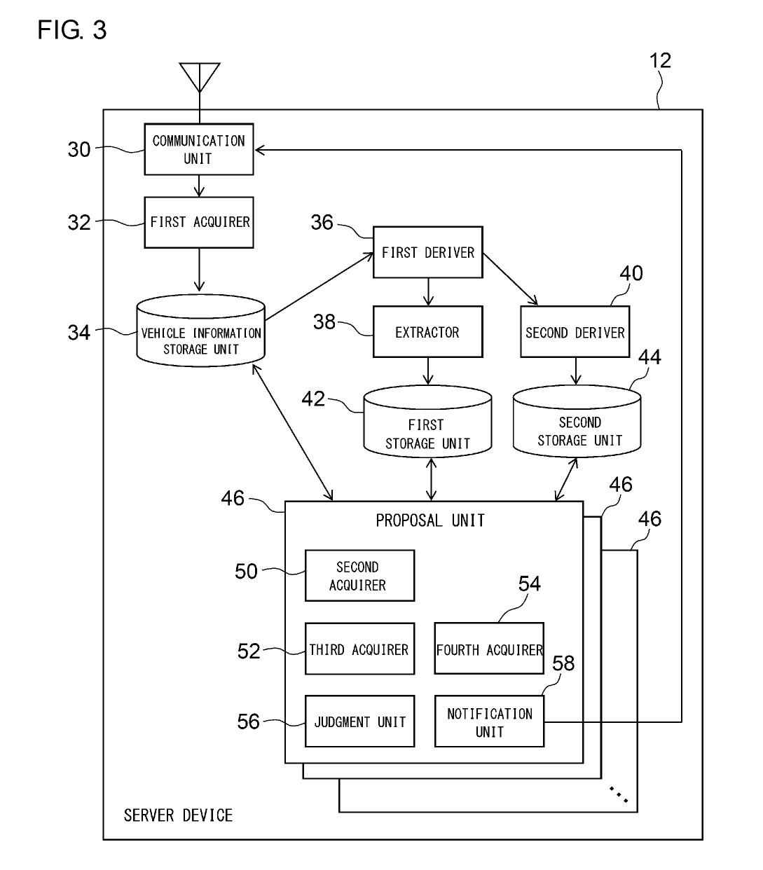

FIG. 3 is a block diagram that shows a configuration of the server device 12 shown in FIG. 1. The server device 12 comprises a communication unit 30, a first acquirer 32, a vehicle information storage unit 34, a first deriver 36, an extractor 38, a second deriver 40, a first storage unit 42, a second storage unit 44, and multiple proposal units 46.

The communication unit 30 performs wireless communication with the communication unit 22 of each of the multiple vehicle-mounted devices 10. The communication unit 30 receives vehicle information of multiple vehicles 14 from the communication units 22 of the multiple vehicle-mounted devices 10. The communication unit 30 outputs the vehicle information of the multiple vehicles 14 to the first acquirer 32.

The first acquirer 32 acquires the vehicle information of the multiple vehicles 14 received by the communication unit 30. The first acquirer 32 then outputs the vehicle information of the multiple vehicles 14 to the vehicle information storage unit 34. Accordingly, the vehicle information storage unit 34 stores the vehicle information of the multiple vehicles 14 acquired by the first acquirer 32.

Based on the vehicle information of the multiple vehicles 14 stored in the vehicle information storage unit 34, the first deriver 36 derives traveling conditions of a vehicle 14 when the user uses a vehicle function. The traveling conditions may include, for example, the type of the road on which the vehicle is traveling, such as an expressway and an ordinary road, and the conditions of the road on which the vehicle is traveling, such as a sloping road, an even road, and a straight road with good visibility. The traveling conditions may also include the traveling place, season, weather, and state of traffic congestion. The traveling place includes latitude and longitude. The road type, road conditions, and traveling place can be identified based on the position information of the vehicle 14 and map data stored in a storage unit, which is not illustrated. The weather and the state of traffic congestion can be identified based on the position information of the vehicle 14, information of transmission date and time of vehicle information, and weather data and traffic congestion information data provided via a network or the like. For example, when the vehicle function is “ACC”, the traveling conditions of the vehicle 14 when the user uses the vehicle function could be “Expressway”, “Daytime”, “Sunny”, and “No traffic congestion”. Also, when the vehicle function is “Shift B”, the traveling conditions of the vehicle 14 when the user uses the vehicle function could be “Ordinary road”, “Downgrade”, and “Traveling place X”. The first deriver 36 outputs the traveling conditions thus derived to the extractor 38 and the second deriver 40.

The extractor 38 regularly extracts a recommended traveling situation from the multiple traveling conditions derived by the first deriver 36. For example, the extractor 38 extracts, for each vehicle function, a traveling condition of which the frequency of occurrence is a predetermined number of times or more, as a recommended traveling situation. The predetermined number of times can be appropriately determined through experiments or the likes. When the vehicle function is “ACC” and when the traveling conditions are “Expressway” and “No traffic congestion”, for example, if the frequency of occurrence of each of the traveling conditions is the predetermined number of times or more, the traveling conditions will be extracted as the recommended traveling situation. This is because, a traveling condition of which the frequency of occurrence is the predetermined number of times or more is likely to be suitable for use of the vehicle function. On the other hand, when the traveling conditions are “Ordinary road” and “Traffic congestion”, for example, and if the frequency of occurrence of each of the traveling conditions is less than the predetermined number of times, the traveling conditions will not be extracted as the recommended traveling situation. This is because, a traveling condition of which the frequency of occurrence is less than the predetermined number of times is likely to be unsuitable for use of the vehicle function.

The recommended traveling situation for a vehicle function may include multiple traveling conditions. The extractor 38 stores the recommended traveling situation thus extracted in the first storage unit 42. The first storage unit 42 stores the recommended traveling situation for each vehicle function. Namely, the recommended traveling situation is specific to each vehicle function and is regularly updated. The frequency of deriving the traveling conditions and the frequency of extracting the recommended traveling situation can be appropriately determined through experiments or the likes.

Based on the multiple traveling conditions derived by the first deriver 36, the second deriver 40 regularly derives the usage situation of each vehicle function for each user and stores the usage situation of each vehicle function thus derived in the second storage unit 44. Namely, the usage situation of a vehicle function is specific to each user and is regularly updated. The second storage unit 44 stores the usage situations of vehicle functions of multiple users.

The usage situation of a vehicle function of a user will be a usage situation “A”, “B”, or “C”, as described below. The usage situation “A” means that the user has never used the vehicle function. The user in the usage situation “A” may not know the existence of the vehicle function, or may not know the situation where the vehicle function should be used. Therefore, it is considered that the user in this situation may suitably be notified of the situation where the vehicle function should be used.

In the usage situation “B”, the user has not recently used the vehicle function for a predetermined period of time since the user used the vehicle function when the traveling conditions of the vehicle did not correspond to the recommended traveling situation. The predetermined period of time may be several months, for example, and can be appropriately determined through experiments or the likes. The user in the usage situation “B” may not know the situation where the vehicle function should be used and might have used the vehicle function in an unsuitable situation. Accordingly, the user might have been unable to utilize the vehicle function and have stopped using the vehicle function thereafter. Or the user may not have had an opportunity to use the vehicle function after the user used the vehicle function in an unsuitable situation. Therefore, it is considered that the user in this situation may also suitably be notified of the situation where the vehicle function should be used.

In the usage situation “C”, the traveling conditions of the vehicle 14 at the time when the user last used the vehicle function corresponded to the recommended traveling situation. The user may be continuously using the vehicle function, or may not have recently used the vehicle function for a predetermined period of time. The user in the usage situation “C” knows the situation where the vehicle function should be used and uses the vehicle function in a suitable situation. Accordingly, even though the user has not recently used the vehicle function for the predetermined period of time, it may be because the user has not had an opportunity to use the vehicle function or has stopped using the vehicle function for some reason. Therefore, it is considered that the necessity to notify the user in this situation of the situation where the vehicle function should be used is low.

Each of the multiple proposal units 46 determines whether or not to offer, to a predetermined user, a proposal for using a vehicle function. Each of the multiple proposal units 46 has the same functions except offering a proposal to a different user. A proposal unit 46 comprises a second acquirer 50, a third acquirer 52, a fourth acquirer 54, a judgment unit 56, and a notification unit 58.

The second acquirer 50 acquires, from the vehicle information storage unit 34, current vehicle information of the vehicle 14 of the target user. The second acquirer 50 then outputs the current vehicle information to the judgment unit 56. The third acquirer 52 acquires the recommended traveling situations from the first storage unit 42. The third acquirer 52 then outputs the recommended traveling situations to the judgment unit 56. The fourth acquirer 54 acquires from the second storage unit 44 the usage situation of each vehicle function of the target user. The fourth acquirer 54 then outputs the usage situation of each vehicle function of the user to the judgment unit 56.

Based on the current vehicle information acquired by the second acquirer 50, the recommended traveling situations acquired by the third acquirer 52, and the usage situation of each vehicle function of the user acquired by the fourth acquirer 54, the judgment unit 56 judges whether or not a proposal for using a vehicle function is required.

When the usage situation of a vehicle function of the user is the usage situation “A” or the usage situation “B” and when the current traveling conditions of the vehicle 14 correspond to the recommended traveling situation for the vehicle function, the judgment unit 56 judges that notification of a proposal for using the vehicle function is required. The judgment unit 56 identifies the current traveling conditions of the vehicle 14 based on the current vehicle information of the vehicle 14, map data, weather data, and traffic congestion information data, etc.

For example, it is assumed here that the vehicle function is “ACC” and the recommended traveling situation therefor is “Expressway” and “No traffic congestion”. When the usage situation of the vehicle function of the user is the usage situation “A” or the usage situation “B”, if an operation for using “ACC” has not been performed and there is no traffic congestion at the time when a predetermined period of time, such as one minute, has elapsed after the vehicle 14 merged into traffic on an expressway, the judgment unit 56 judges that notification of a proposal for using the vehicle function is required. As another example, it is assumed that the vehicle function is “Shift B” and the recommended traveling situation therefor is “Ordinary road”, “Downgrade”, and “Traveling place X”. When the usage situation of the vehicle function of the user is the usage situation “A” or the usage situation “B”, if an operation for using “Shift B” has not been performed at the time when a predetermined period of time, such as several seconds, has elapsed after the vehicle 14 reached a downgrade at the traveling place X on an ordinary road, the judgment unit 56 judges that notification of a proposal for using the vehicle function is required.

When the usage situation of the vehicle function of the user is the usage situation “C”, the judgment unit 56 judges that notification of a proposal for using the vehicle function is not required.

The judgment unit 56 outputs the judgment result to the notification unit 58. When the judgment unit 56 has judged that notification of a proposal for using the vehicle function is required, the notification unit 58 notifies, via the communication unit 30, the vehicle 14 of the target user of a proposal for using the vehicle function. More specifically, the notification unit 58 outputs information of the proposal for using the vehicle function to the communication unit 30. The communication unit 30 then transmits the information of the proposal for using the vehicle function to the vehicle 14 of the target user. To the information of the proposal for using the vehicle function, information for identifying the vehicle 14 as the transmission destination is attached.

Namely, when the traveling conditions of a vehicle 14 of a user who is not using a vehicle function correspond to the recommended traveling situation for the vehicle function, the notification unit 58 notifies the vehicle 14 of a proposal for using the vehicle function. The user who is not using a vehicle function is a user who has not used the vehicle function since the user used the vehicle function when the traveling conditions of the vehicle 14 did not correspond to the recommended traveling situation, or a user who has never used the vehicle function. When the traveling conditions of a vehicle 14 at the time when a user last used a vehicle function corresponded to the recommended traveling situation for the vehicle function, the notification unit 58 does not notify the vehicle 14 of the user of a proposal for using the vehicle function.

Referring back to FIG. 2, the communication unit 22 of the vehicle-mounted device 10 on the vehicle 14 of the target user receives the information of the proposal for using the vehicle function transmitted from the communication unit 30 of the server device 12. The communication unit 22 provides the information of the proposal for using the vehicle function to the output unit 24. Thereafter, the output unit 24 provides the proposal for using the vehicle function to the user. The output unit 24 may be configured to visually output the proposal for using the vehicle function by displaying text and images, may be configured to aurally output the proposal for using the vehicle function by outputting sound, or may be configured to be a combination thereof. Upon being notified of the proposal for using the vehicle function, the user can comprehend that the traveling conditions are suitable for use of the vehicle function.

When the user uses the vehicle function according to the notification of the proposal for using the vehicle function, the usage situation of the vehicle function of the user derived by the second deriver 40 is changed to the usage situation “C”. Accordingly, unless the usage situation is changed to the usage situation “B” again, the notification of a proposal for using the vehicle function will not be performed thereafter. When the user does not use the vehicle function despite the notification of the proposal for using the vehicle function, on the other hand, the usage situation of the vehicle function of the user is not changed. Accordingly, when the traveling conditions of the vehicle 14 correspond to the recommended traveling situation, the notification of a proposal for using the vehicle function will be performed again.

The configuration described above may be implemented by a CPU or memory of any given computer, an LSI, or the like in terms of hardware, and by a memory-loaded program or the like in terms of software. In the present embodiment is shown a functional block configuration realized by cooperation thereof. Therefore, it would be understood by those skilled in the art that these functional blocks may be implemented in a variety of forms by hardware only, software only, or a combination thereof.

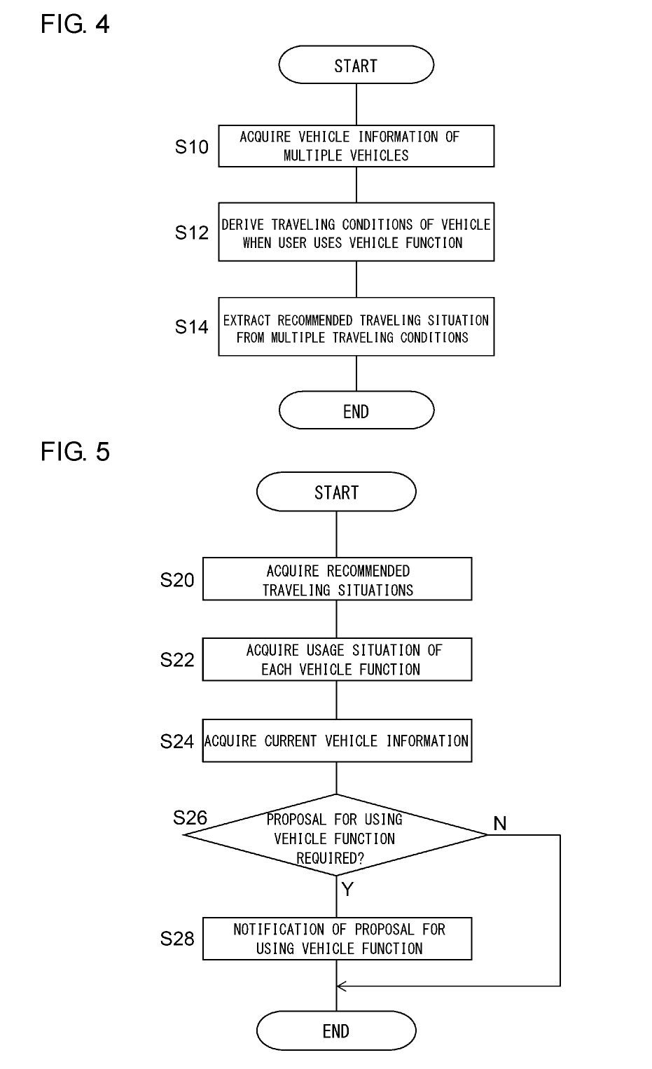

There will now be described the overall operation performed by the vehicle system 1 having the configuration set forth above. FIG. 4 is a flowchart that shows processing for extracting a recommended traveling situation performed by the server device 12 shown in FIG. 1. The processing shown in FIG. 4 is regularly repeated. The server device 12 acquires vehicle information of multiple vehicles 14 (S10), derives traveling conditions of a vehicle 14 when a user uses a vehicle function (S12), and extracts a recommended traveling situation from the multiple traveling conditions thus derived (S14).

FIG. 5 is a flowchart that shows processing for notification of a proposal for using a vehicle function performed by the server device 12 shown in FIG. 1. The processing shown in FIG. 5 is regularly repeated. A proposal unit 46 acquires recommended traveling situations (S20), acquires the usage situation of each vehicle function of a predetermined user (S22), and acquires the current vehicle information of the vehicle 14 of the user (S24). Based on the recommended traveling situations, the usage situation of each vehicle function of the user, and the current vehicle information, the judgment unit 56 judges whether or not a proposal for using a vehicle function is required, and, when the proposal is required (Y at S26), the proposal unit 46 notifies the vehicle 14 of the user of a proposal for using the vehicle function (S28), and the processing is terminated. When the proposal for using a vehicle function is not required (N at S26), the processing is terminated.

According to the present embodiment, in the server device 12, the first storage unit 42 stores the recommended traveling situation for each vehicle function based on the vehicle information of multiple vehicles 14, and the second storage unit 44 stores the usage situation of each vehicle function for each user based on the vehicle information of the multiple vehicles 14. When the traveling conditions of a vehicle 14 of a user who is not using a vehicle function correspond to the recommended traveling situation for the vehicle function, the vehicle 14 is notified of a proposal for using the vehicle function. Since the user who is not using a vehicle function is a user who has never used the vehicle function, or a user who has not used the vehicle function since the user used the vehicle function when the traveling conditions of the vehicle 14 did not correspond to the recommended traveling situation, a proposal for using the vehicle function can be offered to a user who is likely to need the proposal. Therefore, use of a vehicle function can be appropriately proposed.

Also, since the server device 12 collects vehicle information of multiple vehicles 14 and extracts a recommended traveling situation based on the vehicle information, an accurate recommended traveling situation can be obtained based on the vehicle information of the multiple vehicles 14. For example, when there is a specific traveling place where a specific vehicle function is frequently used, the traveling place may be extracted as a recommended traveling situation.

Also, when the traveling conditions of a vehicle 14 at the time when a user last used a vehicle function corresponded to the recommended traveling situation for the vehicle function, the vehicle 14 of the user is not notified of a proposal for using the vehicle function. Accordingly, not only a user continuously using the vehicle function but also a user who has not used the vehicle function since the user used the vehicle function in a suitable traveling situation will not be notified of a proposal for using the vehicle function. Therefore, notification of a proposal for using a vehicle function will not be provided to a user who does not need the proposal.

Described above is an explanation based on an exemplary embodiment. The embodiment is intended to be illustrative only, and it will be obvious to those skilled in the art that various modifications to a combination of constituting elements or processes could be developed and that such modifications also fall within the scope of the present disclosure.

For example, the vehicle functions may include a “seat heating function” or the like. The recommended traveling situation for the “seat heating function” may be “All roads” and “Winter season”, for example, which need not be extracted from multiple traveling conditions of multiple vehicles 14 but may be stored in the first storage unit 42 in advance. In this modification, a proposal for using a vehicle function can be offered with respect to more vehicle functions.

What is claimed is:

1. A server device, comprising:
a storage unit storing a recommended traveling situation in which use of a vehicle function provided by a vehicle is recommended; and
a notification unit configured to notify, when traveling conditions of a vehicle of a user who is not using the vehicle function correspond to the recommended traveling situation, the vehicle of a proposal for using the vehicle function, wherein
the user who is not using the vehicle function is a user who has not used the vehicle function since the user used the vehicle function when the traveling conditions of the vehicle did not correspond to the recommended traveling situation.

2. The server device of claim 1, further comprising:
an acquirer configured to acquire vehicle information of a plurality of vehicles;
a deriver configured to derive traveling conditions of a vehicle when a user uses the vehicle function, on the basis of the vehicle information of the plurality of vehicles acquired by the acquirer; and
an extractor configured to extract the recommended traveling situation from traveling conditions derived by the deriver and to store the recommended traveling situation thus extracted in the storage unit.

3. The server device of claim 1, wherein, when traveling conditions of a vehicle at the time when a user last used the vehicle function corresponded to the recommended traveling situation, the notification unit does not notify the vehicle of the user of a proposal for using the vehicle function.

4. A vehicle system, comprising:
a server device; and
a vehicle-mounted device mounted on a vehicle and configured to communicate with the server device,
the server device comprising:
a storage unit storing a recommended traveling situation in which use of a vehicle function provided by a vehicle is recommended; and
a notification unit configured to notify, when traveling conditions of a vehicle of a user who is not using the vehicle function correspond to the recommended traveling situation, the vehicle of a proposal for using the vehicle function, wherein:
the user who is not using the vehicle function is a user who has not used the vehicle function since the user used the vehicle function when the traveling conditions of the vehicle did not correspond to the recommended traveling situation; and
the vehicle-mounted device receives a proposal for using the vehicle function from the notification unit of the server device.
